(19) United States
(12) Patent Application Publication
(10) Pub. No.: US 2005/0136765 A1
(43) Pub. Date: Jun. 23, 2005

(54) Fibrous materials exhibiting thermal change during use

(75) Inventor: Thomas Gerard Shannon, Neenah, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/745,182

(22) Filed: Dec. 23, 2003

(51) Int. Cl. B32B 23/14; B32B 23/02

(52) U.S. Cl. 442/123; 442/153; 442/61

(57) ABSTRACT

Fibrous sheet materials, such as are useful as facial tissue, bath tissue and paper towels, for example, are provided with chemical agents, such as certain salts, which create a temperature change in the sheet when exposed to a particular stimulant, such as water, for example. These materials can provide a soothing feel to the user, either in the form of cooling or heating, depending upon the particular chemistry involved.

### BACKGROUND OF THE INVENTION

Heat and cold are used to convey soothing and healing characteristics to a variety of personal care products. For example, people are quite familiar with the use of hot or cold packs to treat sports injuries or use of cold compresses to cool the body down after exercising. In other products, certain chemicals such as menthol may be employed to give the sensation of cooling, although such sensations are driven by interaction of the chemical with nerves in the skin and does not cause an actual change in the temperature of the body or the object. This also requires that the substance be actually transferred to the skin to produce the desired effect.

Another approach to providing a cooling sensation is to use a lotion that melts upon contact with the user. The heat of fusion causes heat to be drawn away from the user and be utilized for melting the lotion. As no temperature change is associated with the melting process, as heat is drawn away from the user, the skin actually cools. While in theory this should provide a means to produce a product that is capable of changing the temperature of the user's skin, the temperature at which the lotion melts must be closely controlled. Furthermore, the rate at which the lotion melts is slow and an extended period of contact may be required between the user's skin and the lotion. Also, heats of fusion tend to be relatively low for these compounds and the actual change in temperature is minimal, thereby providing imperceptible changes to the user.

A similar approach to cooling is to use a volatile substance. In this case a volatile fluid is applied to the product. In use, the volatile fluid contacts the users skin. When the volatile fluid comes in contact with the skin it starts to vaporize. Heat is drawn away from the skin to vaporize the substance causing a cooling on the skin surface. While such an approach can produce a significant cooling effect the drawbacks are significant. Among those are requirements to have a moist product form, environmental issues related to volatile organic chemical (VOC) generation and need to store the product in an airtight container when not in use. Addtionally these volatile components can be harsh to the skin and can causing stinging and other discomfort.

Therefore, there is a need to produce a fibrous sheet that has the capability to provide a warming or cooling sensation. There is a further need for this sheet to be produced such that it is capable of being stored in the dry state, has a low VOC content and is not irritating to the skin. There is a further need for this sheet to have a relatively low caliper such that it is suitable for wiping the body. There is a further need for such sheets not to transfer undesireable chemicals to the user's skin.

### SUMMARY OF THE INVENTION

In general, the invention resides in a product comprising an absorbent fibrous sheet containing one or more chemical agents that react exothermically or endothermically when the sheet is subjected to an externally-applied non-thermal stimulus such that the temperature of the sheet increases or decreases at least 1° C. or greater.

More specifically, in one embodiment the invention resides in a product comprising an absorbent fibrous sheet containing one or more encapsulated chemical agents that react exothermically or endothermically when the sheet is subjected to pressure sufficient to break the capsules and release the encapsulated chemical agent(s).

In another embodiment, the invention resides in a product comprising an absorbent fibrous sheet containing one or more salts that react exothermically or endothermically when the sheet is wetted. Such sheets may incorporate salts within a non-hygroscopic encapsulate that is water soluble. When water contacts the capsule containing said salts the capsule and salts dissolve to create a heating or cooling effect.

In particular, it has been discovered that by incorporating various salts into fibrous sheets, such as are useful as tissues, towels or other personal wiping products, a significant endothermic or exothermic temperature change is provided when the sheets are wetted. Whether the sheet warms or cools is dependent upon the enthalpy of solution of the salt or salts being used. When water is absorbed by the sheet, the salt or salts dissolve and a noticeable temperature change is created. This temperature change occurs within the sheet itself and does not require transfer of an ingredient in the product to the user's skin. This temperature change is sufficient to be noticeable by the user. The products of this invention can have a wide range of applicability for wiping the hands, face and body since the temperature change can be initiated by absorption of body fluids, such as sweat or surface moisture on the skin, for example. Such products can comprise sheets of synthetic and/or natural fibers formed by an air-laying or wet-laying process, for example. The invention encompasses not only end-user product forms, but also intermediate basesheet materials useful as components for disposable personal care articles and other applications.

In general, the invention resides in a product comprising an absorbent fibrous sheet containing one or more chemical agents that react exothermically or endothermically when the sheet is subjected to an externally-applied non-thermal stimulus such that the temperature of the sheet increases or decreases at least 1° C. or greater.

More specifically, in one embodiment the invention resides in a product comprising an absorbent fibrous sheet containing one or more encapsulated chemical agents that react exothermically or endothermically when the sheet is subjected to pressure sufficient to break the capsules and release the encapsulated chemical agent(s). In another embodiment said encapsulants are water soluble such that with addition of water the encapsulants dissolve and the chemical reaction occurs.

In another embodiment, the invention resides in a product comprising an absorbent fibrous sheet containing one or more salts that react exothermically or endothermically when the sheet is wetted.

For various dry wiping products, such as facial tissue, bath tissue or paper towels, for example, upon contact with water the temperature of the sheet will rise or fall depending upon the desired effect. For other applications, sheets in accordance with this invention can also be used as a sports wipe, where sweat absorbed by the product causes the dissolution of a material with an endothermic enthalpy of solution to produce a cooling effect. They could also be used as a disposable towel, whereupon as water is absorbed from the body, a salt having an exothermic enthalpy of solution is dissolved to provide an increase in temperature and a warming sensation to the body. Other product executions include products intended to be worn against the body and which would heat or cool the body as body moisture was introduced into the product. For example, a disposable headband or a sweat band would provide a cooling sensation as it is worn. Another possible application would be disposable rain garments, wherein a small amount of rain could be allowed to pass into the garment allowing for dissolution of a salt with an exothermic heat of solution, thereby causing an increase in the temperature of the garment and providing a warming sensation to the user.

In the specific embodiments described above, the mechanism for producing the temperature change is due to the enthalpy of solution of the various salts being used. However, it is within the scope of this invention to induce the change in temperature by other reaction mechanisms. For example, two chemicals capable of reacting with each other can be applied in discrete locations on the sheet. For example, in a multi-ply sheet, one chemical can be incorporated within the inner ply and the other chemical can be incorporated within one or more outer plies of the the sheet. When the sheet is dry, the chemicals do not migrate through the sheet and can not contact each other. Hence, no chemical reaction occurs. However, when water is applied to the sheet, the chemicals now become mobile and can interact with each other within the sheet. The resulting chemical reaction causes an increase or decrease in the temperature of the sheet depending upon the heat of reaction associated with the specific chemical interaction. Examples of using chemical reactions to provide electrochemical heat sources are described in U.S. Pat. No. 5,538,020 issued to Farrier and assigned to R. J. Reynolds Tobacco Company, which is herein incorporated by reference.

Although in some embodiments the specific temperature change is induced by addition of water and use of salts with very highly positive or negative enthalpies of solution, wiping products that produce a temperature change when exposed to an external stimulus besides water and where the temperature change occurs via a different mechanism is possible. For example, two separate chemicals can be encapsulated and incorporated within the tissue. When the capsules are broken, the chemicals inside the capsules are allowed to mix and a chemical reaction that produces or absorbs heat causes the temperature to rise or fall. For example, acids and bases could be added to the tissue as separate encapsulated materials. When the tissue is subjected to external working stresses in use, the capsules break, thereby causing an acid-base neutralization reaction and the release of heat.

For wiping products in general, the chemicals used to create the temperature change will not be located on the exterior surfaces of the wiping product. In many cases it will be preferred to not have the chemical come in direct contact with the user's skin because of possible skin irritation. There are a variety of means by which the chemicals can be incorporated into the products of this invention to minimize the potential for skin contact. If the wiping product is a multi-ply product having three, four, five or more plies, for example, the chemical or chemicals that produce the temperature change can be located within the inner ply or plies. When an external stimulus (such as water addition) is applied to the product, a reaction occurs in the chemically treated ply or plies and the product heats or cools accordingly. Most of the reaction is contained within the inner ply or plies with little of the chemical(s) transferring to the outer plies. In another embodiment, the dry chemical reagent that produces the temperature change can be encapsulated in a particle having a water soluble outer shell. When water is absorbed by the product, the outer shell dissolves and the chemical and water will react to produce a temperature change. In still another embodiment, the reactive chemical is dissolved or dispersed within a water-soluble film sandwiched between two absorbent plies. When water contacts the film, the film dissolves, thereby releasing the chemical. As the chemical is released, it reacts with the water to produce the desired temperature change. In still another embodiment, the chemical can be applied and absorbed into fibers, such as by soaking the fibers in a solution of the chemical. The fibers are removed from the solution, dried and individualized to form a fluff pulp-type material. The treated fluff pulp fibers can be incorporated into a central ply of a multi-ply product or within a layer of a multi-layer ply to provide an absorbent product capable of producing the desired temperature change.

The chemicals can be applied to the sheet by any suitable means known in the art. This can include, without limitation: addition as solid particles sprayed onto the sheet; spraying an aqueous solution of the chemicals onto the sheet and subsequently drying the sheet; pretreating fibers with the salts or other chemicals prior to final drying; applying microspheres containing the chemicals; dipping the sheet into a solution of the chemicals followed by drying; application as a film; etc.

The amount of chemical applied to the product will depend on the product and the particular chemicals chosen, but must be sufficient to provide a temperature change that is noticeable to the user. In absolute value terms (either an increase or decrease in temperature), the change in temperature can be 1° C. or greater, more specifically about 3° C. or greater, more specifically about 5° C. or greater, more specifically from 1° C. to about 10° C., still more specifically from about 2° C. to about 10° C. and still more specifically from about 3° C. to about 6° C. When enthalpies of solution for salts are used to affect the temperature change, it is advantageous if the enthalpy of solution of the salt at infinite dilution is about 2,000 cal/mole or greater at 25° C. if cooling is desired and −2,000 cal/mole or less at 25° C. if warming is desired. Higher enthalpy of solution values (for cooling) and lower values (for heating), respectively, are advantageous because less salt is required to yield the desired temperature change. Some specific salts useful for purposes of this invention include, without limitation, KCl with a ΔHO°∞ of 4,115 cal/mole, NH₄NO₃ with a ΔH°∞ of 6,400 cal/mole, NaNO₃ with a ΔH°∞ of 4,900 cal/mole, NH₄Cl with a ΔH°∞ of 3,533 cal/mole, CaCl₂ with a ΔH°∞ of −8,102 cal/mole, LiCl with a ΔHO°∞ of −8,850 cal/mole, NaC₂H₃O₂ with a ΔH°∞ of −4,140 cal/mole. Enthalpy of solution values for these and other monovalent salts can be found in the CRC Handbook, 72^{nd} edition, p. 5-101.

When deliquescent salts such as calcium chloride or lithium chloride are used, it is necessary to prevent such materials from coming in contact with moisture from the air prior to use. Such salts are capable of absorbing sufficient moisture from the air to go into solution. As such, the salts will slowly absorb moisture from the air and warm with time. However, once equilibrium moisture is reached they no longer are capable of warming with addition of more water. Moisture from the air may be precluded from the sheet by encapsulating said salts as previously described, use of sealed packages, or any other packaging technique generally known in the art from preventing atmospheric moisture from contacting moisture sensitive materials until use.

The basis weight of the absorbent fibrous sheets useful for purposes of this invention can have a basis weight of from about 5 g/m² to about 200 g/m². For use as a facial tissue or bath tissue, the basis weight range can be from about 5 g/m² to about 50 g/m² For paper towels and the like, the basis weight range can be from about 15 g/m² to about 200 g/m².

In addition, absorbent fibrous sheets useful herein for facial tissue, bath tissue, paper towels and the like can also be characterized by a sheet bulk of about 2 cm³/g or greater, more specifically from about 5 to about 20 cm³/g or greater. The sheet bulk is calculated as the quotient of the caliper (hereinafter defined) of the sheet, expressed in microns, divided by the dry basis weight, expressed in grams per square meter. The resulting sheet bulk is expressed in cubic centimeters per gram. More specifically, the caliper is measured as the total thickness of a stack of ten representative sheets and dividing the total thickness of the stack by ten, where each sheet within the stack is placed with the same side up. Caliper is measured in accordance with TAPPI test methods T402 “Standard Conditioning and Testing Atmosphere For Paper, Board, Pulp Handsheets and Related Products” and T411 om-89 “Thickness (caliper) of Paper, Paperboard, and Combined Board” with Note 3 for stacked sheets. The micrometer used for carrying out T411 om-89 is an Emveco 200-A Tissue Caliper Tester available from Emveco, Inc., Newberg, Oreg. The micrometer has a load of 2.00 kilo-Pascals (132 grams per square inch), a pressure foot area of 2500 square millimeters, a pressure foot diameter of 56.42 millimeters, a dwell time of 3 seconds and a lowering rate of 0.8 millimeters per second. The caliper of the products of this invention can be from about 10 to about 4000 microns, more specifically from about 100 to about 2000 microns, and still more specifically from about 100 to about 800 microns.

Optional chemical additives may also be added to the formed basesheet or product to impart additional benefits to the product and process provided they are not antagonistic to the intended benefits of the invention. Examples of such additives include charge promoters, wet strength agents (permanent and temporary), dry strength agents, debonders and softening agents, all of which are well known in the art. Such chemicals may be added at any point in the process, including being added simultaneously with the chemicals providing the temperature change.

Charge promoters and control agents are commonly used in the papermaking process to control the zeta potential of the papermaking furnish in the wet end of the process. These species may be anionic or cationic, most usually cationic, and may be either naturally occurring materials such as alum or low molecular weight high charge density synthetic polymers typically of molecular weight less than 500,000. Drainage and retention aids may also be added to the furnish to improve formation, drainage and fines retention. Included within the retention and drainage aids are microparticle systems containing high surface area, high anionic charge density materials.

Wet strength agents and dry strength agents may also be applied to the web, either directly or to the fibers within the web prior to web formation. As used herein, “wet strength agents” are materials used to immobilize the bonds between fibers in the wet state. Typically, the means by which fibers are held together in paper and tissue products involve hydrogen bonds and sometimes combinations of hydrogen bonds and covalent and/or ionic bonds. In the present invention, it can be useful to provide a material that will allow bonding of fibers in such a way as to immobilize the fiber-to-fiber bond points and make them resistant to disruption in the wet state. In this instance, the wet state usually will mean when the product is largely saturated with water or other aqueous solutions, but could also mean significant saturation with body fluids such as urine, blood, mucus, menses, runny bowel movement, lymph and other body exudates.

Any material that, when added to a paper web or sheet results in providing the sheet with a ratio of the mean wet geometric tensile strength to the mean dry geometric tensile strength in excess of 0.1 is, for purposes of this invention, a wet strength agent. Typically these materials are termed either as “permanent” wet strength agents or as “temporary” wet strength agents. For the purposes of differentiating permanent from temporary wet strength, permanent will be defined as those resins which, when incorporated into paper or tissue products, will provide a product that retains more than 50 percent of its original wet strength after exposure to water for a period of at least five minutes. Temporary wet strength agents are those which show less than 50 percent of their original wet strength after being saturated with water for five minutes. The amount of wet strength agent added to the pulp fibers prior to web formation can be about 0.1 dry weight percent or greater, more specifically about 0.2 dry weight percent or greater, and still more specifically from about 0.1 to about 3 dry weight percent, based on the dry weight of the fibers. Permanent wet strength agents will provide a more or less long-term wet resilience to the structure. In contrast, the temporary wet strength agents would provide structures that had low density and high resilience, but would not provide a structure that had long-term resistance to exposure to water or body fluids.

Temporary wet strength additives can be cationic, nonionic or anionic. Exemplary commercially available compounds include: PAREZ™ 631 NC and PAREZ® 725, which are cationic glyoxylated polyacrylamides available from Cytec Industries (West Paterson, N.J.); Hercobond 1366, which is also a cationic glyoxylated polyacrylamide manufactured by Hercules, Inc. (Wilmington, Del.); and dialdehyde starches, such as Cobond 1000® from National Starch and Chemical Company.

Permanent wet strength agents comprising cationic oligomeric or polymeric resins useful for purposes herein include polyamide-polyamine-epichlorohydrin type resins such as KYMENE 557H sold by Hercules, Inc. (Wilmington, Del.). Other cationic resins include polyethylenimine resins and aminoplast resins obtained by reaction of formaldehyde with melamine or urea. It is often advantageous to use permanent and/or temporary wet strength resins in the manufacture of tissue products such as facial tissue, bath tissue and paper towels.

Dry strength resins may also be applied to the web to control the dry strength of the resultant product. Such materials are well known in the art and include, but are not limited to, modified starches and other polysaccharides such as cationic, amphoteric, and anionic starches and guar and locust bean gums, modified polyacrylamides, carboxymethylcellulose, sugars, polyvinyl alcohol, chitosan, and the like. Such dry strength additives are typically added to the fiber slurry prior to sheet formation or as part of the creping package.

At times it may be advantageous to add additional debonders or softening chemistries to the sheet. Examples of debonders and softening chemistries are broadly taught in the art. Exemplary compounds include the simple quaternary ammonium salts having the general formula (R¹)_{4-b}—N⁺—(R¹)_{b}X⁻ wherein R^{1′} is a C₁₋₆ alkyl group, R^{1″} is a C₁₄-C₂₂ alkyl group, b is an integer from 1 to 3 and X⁻ is any suitable counterion. Other similar compounds include the monoester, diester, monoamide and diamide derivatives of the simple quaternary ammonium salts. A number of variations on these quaternary ammonium compounds are known and should be considered to fall within the scope of the present invention. Additional softening compositions include cationic oleyl imidazoline materials such as Prosoft TQ-1003 available from Hercules, Inc. Such softeners may also incorporate a humectant or a plasticizer such as a low molecular weight polyethylene glycol (molecular weight<4,000 daltons) or a polyhydroxy compound such as glycerin or propylene glycol. These softeners may be applied to the fibers while in slurry prior to sheet formation to aid in bulk softness.

When salts are incorporated at relatively high levels into the sheet, a certain level of grittiness may be imparted to the sheet. To counteract this grittiness, it can be beneficial to topically apply a polysiloxane to the sheet to improve the surface feel. The presence of the polysiloxane will have little impact on the temperature change and, in general, any polysiloxane known in the art to be useful as a topical softening agent can be used to impart the desired softness to the product or basesheet. Particularly suitable polysiloxanes include the aminofunctional polysiloxanes, polyether polysiloxanes, aminofunctional polyether polysiloxanes and mixtures thereof. When using polysiloxanes with sheets of the present invention, if water is used as the external trigger to cause the temperature change, the polysiloxane should be used at a level or in conjunction with wetting agents such that the hydrophobicity of the product does not exceed certain limits. To this end, the Automtic Gravimetric Absorbency Test (AGAT) (define below) can be used to measure the intake of water into the products. The AGAT values for the products of the present invention can suitably be about 0.4 g/g/s^{1/2} or greater, more specifically about 0.5 g/g/s^{1/2} or greater, and more specifically about 0.7 g/g/s^{1/2} or greater. Where water is not used as the activator to induce the temperature change, no specific requirements are necessary for water intake rates with respect to the function of the invention.

The “Automatic Gravimetric Absorbency Test” (AGAT) is a test that generally measures the initial absorbency of a tissue sheet which has been aged for 2 weeks at 130° F. The apparatus and test are well known in the art and are described in U.S. Pat. No. 4,357, 827 entitled Gravimetric Absorbency Tester and issued Nov. 9, 1982 to McConnell, which is incorporated herein by reference. In general, the AGAT value is determined by testing a stack of six representative samples of a tissue product. During testing, the sample stack is placed on the test cell that is in communication with the reservoir vessel. A valve is then opened so that liquid is free to flow from the vessel to the test cell. The stack of tissues being tested absorbs liquid from the reservoir vessel. The amount of liquid taken up by the stack is determined over a period of time. In particular, the AGAT machine generates an absorption curve from 2.25 seconds to as long as desired. The AGAT result is obtained by measuring the average slope from between 2.25 and 6.25 seconds. Ten replicates are run for each product and the average of the 10 replicates is the AGAT value for that product.

Other chemicals that may be added to the products of this invention include absorbency aids, usually in the form of cationic, anionic, or non-ionic surfactants, humectants and plasticizers, such as low molecular weight polyethylene glycols, and polyhydroxy compounds, such as glycerin and propylene glycol. Materials that supply skin health benefits, such as mineral oil, aloe extract, vitamin E, lotions in general and the like may also be incorporated into the tissue. Further materials include odor control agents, such as odor absorbents, activated carbon fibers and particles, baby powder, baking soda, chelating agents, zeolites, perfumes or other odor-masking agents, cyclodextrin compounds, oxidizers, and the like. Superabsorbent particles, synthetic fibers, or films may also be employed. Additional options include cationic dyes, optical brighteners, humectants, emollients, fillers such as kaolin clay, titanium dioxide, talc and the like.

In the interests of brevity and conciseness, any ranges of values set forth in this specification contemplate all values within the range and are to be construed as written description support for claims reciting any sub-ranges having endpoints which are whole number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

### EXAMPLES

Approximately 5 grams of NaNO₂ was dissolved in 100 cc of distilled water. A standard two-ply facial tissue was then soaked in the solution and excess water wrung out by hand. The tissue sheet was placed in an oven at 65° C. and allowed to dry for 1 hour. The sheet was removed from the oven and allowed to cool.

In a similar manner, about 5 grams of CaCl₂ was dissolved in 100 cc of distilled water. A standard two-ply facial tissue was then soaked in the solution and excess water wrung out by hand. The tissue sheet was placed in an oven at 65° C. and allowed to dry for 1 hour. The sheet was removed from the oven and allowed to cool in a vacuum desicator. After cooling the sheet was immediately cut to size and sampled as below.

Each of the tissue sheets above were cut into approximately 1″ strips weighing 0.5 grams. The strip was then wrapped securely around the bulb of a thermometer and the temperature recorded. Transparent tape, such as Scotch® brand transparent tape can be used to secure the strip to the thermometer provided sufficient exposed tissue is present to allow absorption of the water. The thermometer was then placed in a 10 cc vial and 1.0 cc of distilled water was then added to the tissue and the change in temperature recorded. [Note: when using solutions that cool it is necessary to use a vial so that evaporation of the water does not lead to erroneous results.] The temperature was watched to determine the maximum or minimum temperature that was achieved. The results are listed in the table below.

| Sample | Dry Temperature | Wet Temperature | Change |
|---|---|---|---|
| Control | 23.6° C. | 23.5° C. | −0.1° C. |
| NaNO₂ | 23.6° C. | 20.1° C. | −3.5° C. |
| CaCl₂ | 24.5° C. | 29.8° C. | +5.3° C. |

It will be appreciated that the foregoing description and examples are for purposes of illustration and are not to be construed as limiting the scope of the invention, which is defined by the following claims and all equivalents thereto.

1. A product comprising an absorbent fibrous sheet containing one or more chemical agents that react exothermically or endothermically when the sheet is subjected to an externally-applied non-thermal stimulus such that the temperature of the sheet increases or decreases at least 1° C. or greater.

2. The product of claim 1 wherein one or more of the chemical agents are encapsulated and the externally applied non-thermal stimulus is pressure sufficient to break the capsules and release the encapsulated chemical agent(s).

3. The product of claim 1 wherein one or more of the chemical agents are encapsulated in a water-soluble encapsulant and the externally applied non-thermal stimulus is water absorbed into the sheet to dissolve the capsules and release the encapsulated chemical agent(s).

4. The product of claim 1 wherein the externally applied non-thermal stimulus is water absorbed into the sheet.

5. The product of claim 1 wherein the reaction is exothermic.

6. The product of claim 1 wherein the reaction is endothermic.

7. The product of claim 1 wherein at least one of the chemical agents is a salt.

8. The product of claim 7 wherein the absolute value of the enthalpy of solution of the salt is about 2,000 calories per mole or greater.

9. The product of claim 8 wherein the salt is selected from the group consisting of KCl, NH₄NO₃, NaNO₃, NH₄Cl, CaCl₂, LiCl and NaC₂H₃O₂.

10. The product of claim 1 wherein the fibers of the absorbent fibrous sheet consist essentially of cellulosic fibers.

11. The product of claim 1 selected from the group consisting of facial tissue, bath tissue and paper towels.

12. The product of claim 1 wherein the temperature of the sheet increases or decreases about 3° C. or greater.

13. The product of claim 1 wherein the temperature of the sheet increases or decreases about 5° C. or greater.

14. The product of claim 1 wherein the temperature of the sheet increases or decreases from 1° C. to about 10° C.

15. The product of claim 1 wherein the temperature of the sheet increases or decreases from about 2° C. to about 10° C.

16. The product of claim 1 wherein the temperature of the sheet increases or decreases from about 3° C. to about 6° C.

17. The product of claim 1 comprising two outer plies and one or more inner plies, wherein the sheet containing the chemical agents is an inner ply.
